(19) United States
(12) Patent Application Publication
(10) Pub. No.: US 2011/0041715 A1
(43) Pub. Date: Feb. 24, 2011

(54) FLEXOGRAPHIC PRINTING INKS

(76) Inventors: Christopher L. Bower, Ely Cambridgeshire (GB); Phillip J. Coldrick, Cambridge (GB); Stephanie V. Desrousseaux, Ouroux-sur-Saone (FR); Andrew M. Howe, Cambridge (GB)

Correspondence Address: EASTMAN KODAK COMPANY;PATENT LEGAL STAFF, 343 STATE STREET, ROCHESTER, NY, 14650-2201, US

(21) Appl. No.: 12/852,650

(22) Filed: Aug. 9, 2010

(30) Foreign Application Priority Data
Aug. 21, 2009 (GB) 0914654.9

(51) Int. Cl. B41F 31/00; C09D 11/10

(52) U.S. Cl. 101/349.1; 524/565; 524/601; 524/582

(57) ABSTRACT

A flexographic printing composition which comprises a carrier-swellable particle composition, such as a microgel particle composition, has improved printing performance and printing resolution, especially where the flexographic printing composition is an aqueous printing composition and the carrier is water. The composition is particularly beneficial for flexographic printing of such an aqueous printing ink onto low-energy surface substrates or impermeable substrates, in which the ink has improved adhesion, even in the absence of corona discharge treatment. The use of surfactant in an amount of at least 0.5% by weight of the ink composition enhances printed density and/or reduces mottling in solid printed areas.

### CROSS-REFERENCE TO RELATED APPLICATIONS

Reference is made to and priority claimed from GB Application Number 0914654.9, filed Aug. 21, 2009, by Christopher L. Bower et al., and entitled, “FLEXOGRAPHIC PRINTING INKS.”

### FIELD OF THE INVENTION

The invention relates to flexographic printing. In particular, the invention relates to the use of carrier-swellable particles, such as microgel particles, in flexographic printing ink. The invention further relates to such ink formulations comprising such particles, the method of manufacture of such inks and methods of printing using such inks and their uses. The inks of the present invention are suitable for printing on various substrates but find particular application for printing on impermeable substrates.

### BACKGROUND OF THE INVENTION

Flexographic printing has been widely practiced using solvent-based inks, although there is increasing impetus to use water-based inks for flexographic printing. Flexographic printing is a direct rotary printing method that uses resilient relief image plates of rubber or other resilient material to print an image on a diverse range of materials. It has found particular utility in printing in the packaging industry and is used on a range of substrates, absorbent or non-absorbent, such as cardboard, plastic films etc.

A particular challenge in the use of water-based inks for flexographic printing is to print on ‘low energy’ substrates such as polyethylene and polypropylene which typically have a lower surface energy than water. Flexographic inks for printing on lower energy surfaces may be provided in a viscous formulation in order to minimise the amount of spread on the substrate and to prevent settlement of pigment. However, the viscosity is limited by the practical requirements of printing. In order to effectively print on such low-energy surfaces with water-based inks, it is necessary for the ink to have effective wetting on printing to the surface, adhesion of the ink to the substrate and preferably good resolution.

Typically, wetting can be assisted by adding quantities of organic solvents to the aqueous dispersion. However, regulations limit the amount of volatile organics that can be used. U.S. Pat. No. 4,765,243 attempts to overcome the problem by incorporating certain silicone polymers into the printing ink in an amount of 0.1 to 1%. However, even using this formulation, low energy substrates require corona discharge treatment.

Adhesion of inks to low energy substrates is most commonly achieved using UV-curable inks. Typically, the ink will be applied to the flexographic printing plate, and prior to contact with the substrate, the substrate will be treated with a corona discharge, the ink is then applied to the substrate and subsequently treated with UV radiation to cure the ink in position on the substrate. However, such a process requires two additional steps compared with solvent based inks, namely a corona-discharge step and a UV irradiation step.

In order to produce good images in flexographic printing, it is essential that the ink is applied to the substrate in a uniform and predictable manner which in turn requires that the relief areas of the flexographic printing plate also carry ink in a uniform and predictable way. This is achieved using anilox metering rolls for applying the ink to the printing plate and by the design of the printing plate

It is a well known problem in flexographic printing that solid printed areas can be subject to an effect known as mottling, whereby the solid printed areas appear to be printed less uniformly and with variable saturation. Thus an area with coverage of say 98% appears darker than an area intended to have a solid (100%) ink coverage and the edges of solid areas are often characterised by a halo effect. U.S. Pat. No. 6,213,018 attempts to solve this problem by providing on the relief portions of the flexographic printing plate a plurality of ink-carrying cells in a regular pattern of rows and columns orientated at an angle acute to those ink-carrying cells of the anilox metering roll. This arrangement alleviates the problem of mottling, lack of saturation and halo effect by improving the ink-carrying ability of the relief portions of the printing plate. However, it requires the arrangement of the flexographic printing plate to be significantly more complex and has an enhanced risk of reduction in the resolution of printed lines.

There is a need for flexographic printing inks that provide improved resolution, improved printing performance over a range of conditions and improved print quality, especially for aqueous printing inks and for printing on substrates with low surface energy. There is further a need for flexographic printing inks that reduce the undesirable effects of mottling in solid printed areas.

The inventors have found that the use of carrier-swellable polymer particles, such as microgel particles, in a flexographic printing ink comprising a corresponding carrier provides improved rheological properties and can thereby produce enhanced printing performance, a simpler printing procedure and improved printing results. The inventors have further found that the undesirable effect of mottling can be overcome in such particle-containing inks by addition of certain quantities of dispersants and/or surfactants.

### PROBLEM TO BE SOLVED BY THE INVENTION

It is an objective of the inventors to improve flexographic printing ink compositions in order to improve the printing process such that the ink can be printed onto low-energy plastic surfaces without the need for corona discharge treatment. It is a further objective to provide an improved ink composition that better adheres to substrates having low-energy surfaces. It is a still further object to provide an improved ink composition that gives improved resolution, especially when printing onto low-energy substrate surfaces. It is a still further object to provide an improved ink composition that enables better quality areas of solid print with reduced mottling effects.

### SUMMARY OF THE INVENTION

According to one aspect of the invention, there is provided a use of carrier-swellable polymer particles to enhance printing performance in a flexographic printing process by incorporating carrier-swellable polymer particles into a flexographic printing ink formulation, which ink formulation comprises a carrier capable of swelling the carrier-swellable polymer particles.

In a second aspect of the invention, there is provided a use of a surfactant to improve colour density and/or reduce mottling in solid print areas from a flexographic printing process using a carrier-swellable polymer particulate material-containing flexographic printing ink composition, by incorporating into said ink composition the surfactant in an amount of greater than 0.5% by weight of the ink composition.

In a third aspect of the invention, there is provided a method of improving performance of a flexographic printing ink comprising a carrier liquid, said method comprising incorporating into the printing ink, or adding to the printing ink prior to printing, a carrier-swellable polymer particle formulation.

In a fourth aspect of the invention, there is provided a flexographic printing composition comprising a functional component and a carrier characterised in that it further comprises a carrier-swellable polymer particulate material.

In a fifth aspect of the invention, there is provided a method of manufacturing a flexographic printing composition as defined above.

In a sixth aspect of the invention, there is provided a method of printing using a flexographic printing composition as defined above.

### ADVANTAGEOUS EFFECT OF THE INVENTION

The use of carrier-swellable polymer particles, such as microgel particles, in flexographic printing fluids improves the printing performance of the fluid, especially when using an aqueous flexographic printing ink to print on low-energy or impermeable substrate surfaces. Flexographic printing inks comprising such particles according to the present invention show improved adhesion as well as improved resolution when printing onto low energy substrates, even without corona discharge treatment and without requiring UV-curable components. Thereby, the printing performance is improved and a simple printing performance is achievable.

By incorporating into a swellable polymer particle-containing flexographic printing ink a surfactant in an amount of at least 0.5% by weight of the ink composition, improved density of solid printed areas can be achieved with reduced mottling compared with conventional flexographic printing performance.

The inks have the further benefit of providing improved printing resolution over a wider range of print parameters and improved uniformity of ink coverage.

### BRIEF DESCRIPTION OF THE DRAWINGS

FIG. 1 is a graph of microgel particle size (nm) against temperatures (° C.) for a microgel composition produced according to Example 1;

FIG. 2 shows optical micrographs of a printed aqueous microgel-containing ink comprising sodium dodecyl sulfate surfactant in an amount of 0.12% by weight of ink (FIG. 2a) and in an amount of 1.2% by weight of ink (FIG. 2b);

FIG. 3 shows a graph of printed linewidth (μm) against engagement (of a flexographic printing plate against a substrate) (μm) for each of a 10 μm and a 20 μm line on a PET substrate using each of a conventional UV curable flexographic printing ink and a microgel-containing ink according to the invention;

FIG. 4 shows an image of 10 μm and 20 μm width relief lines printed on a PET substrate using a conventional UV-curable flexographic printing ink at 60 μm engagement;

FIG. 5 shows an image of 10 μm and 20 μm width relief lines printed on a PET substrate using a microgel-containing ink according to the present invention at 60 μm engagement; and

FIG. 6 shows four samples of a biaxially orientated polypropylene substrate printed with an image using: a microgel-containing ink of the present invention with corona discharge treatment (FIG. 6a); a microgel-containing ink of the present invention without corona discharge treatment (FIG. 6b); a conventional UV-curable flexographic printing ink with corona discharge treatment (FIG. 6c); and a conventional UV-curable flexographic printing ink without corona discharge treatment (FIG. 6d).

### DETAILED DESCRIPTION OF THE INVENTION

The flexographic printing process typically comprises several steps which are operating continually to allow printing at high speed and high volume. An ink is applied to an anilox (or meter) roll. The ink may be applied to the anilox roll by, for example, contacting with an ink roll which is partially immersed in the ink to be printed onto the substrate. The anilox roll, which typically has formed on its surface of a plurality of cells, has the function of metering the quantity of ink to be applied to the flexographic printing plate. Typically, prior to inking the printing plate, a doctor blade removes any excess ink from the anilox roller. The metered ink is then applied to the printing plate which in turn contacts with the substrate to print a pattern defined by the relief pattern formed on the printing plate.

The flexographic printing composition according to the present invention, which comprises a functional material and a carrier fluid, further utilises a carrier-swellable polymer particulate which swells in the presence of the carrier fluid of the printing composition. The effect of the carrier-swellable polymer particles, it is believed, is to enhance the rheological properties of the printing composition and especially to improve adhesion of the printed composition to the substrate (e.g. a low-energy surface substrate) and/or to improve resolution of printing on the substrate.

Whilst the carrier fluid may be any suitable carrier fluid for a flexographic printing system, it is preferred that the carrier fluid is an aqueous liquid and that the composition is an aqueous flexographic printing composition.

By aqueous flexographic printing composition, it is meant that the solvent or carrier fluid comprises water in an amount of at least 50% by weight, preferably at least 75%, more preferably at least 90% and still more preferably at least 98%. A purely aqueous composition comprises a carrier fluid consisting essentially of water.

A ‘functional material’ is a material that provides a particular desired mechanical, electrical, magnetic, or optical property. As used herein the term ‘functional material’ preferably refers to a colorant, such as a pigment, which is dispersed in a carrier fluid, or a dye, dispersed and/or dissolved in the carrier fluid, magnetic particles (e.g. for barcoding), conducting or semi-conducting particles, quantum dots, metal oxide or wax. Preferably the functional material, however, is a pigment dispersed in the carrier fluid or a dye dispersed and/or dissolved in the carrier fluid.

Preferably, therefore, according to the present invention, the printing composition is an aqueous flexographic printing ink comprising an aqueous carrier fluid and a colorant, which may be a pigment or a dye, and which further comprises a water-swellable polymer particulate material.

The carrier-swellable polymer particulate material may be any suitable polymer composition which forms discrete particles in the carrier fluid (as opposed, for example, to a linear polymer material with significant multiple inter-polymer crosslinking) which polymer particulate material is compatible with the carrier fluid and preferably also other components of the printing composition. In the case of aqueous carrier, the carrier-swellable polymer particulate is a water-swellable polymer particulate. Preferably, the carrier-swellable polymer particulate material has the effect on the printing composition when added thereto of increasing the viscosity at low-shear whilst rendering it shear thinning.

Without being bound by theory, it is postulated that the printing compositions comprising carrier-swellable polymer particle dispersions have improved printing performance because their viscoelastic properties and shear properties are advantageous in the inking process (e.g. in evenly distributing the printing composition across the anilox roller and more particularly consistent and even application of printing composition to the flexographic printing plate from the anilox roller) and during printing. A relatively high viscosity at low shear and lipophilic content of the particles/particle composition may enable rapid and effective adhesion to low-energy surface substrates, even without corona discharge treatment.

Preferably, the carrier-swellable polymer particulate material is a microgel. Any suitable microgel may be used noting that solvent-swellable microgels, ionic microgels and water-swellable microgels are known. More preferably the microgel is a water-swellable microgel, for an aqueous printing system for printing onto substrates that have low surface energy and/or are impermeable.

The remainder of the disclosure herein will relate more particularly to microgels and in the context typically of water-swellable microgels for an aqueous printing system. However, the particular features discussed should be understood as applying also to the more general disclosure above where the context allows (or should be understood as further disclosing by implication the corresponding feature for a solvent-swellable particulate material). Likewise, the disclosure will tend to refer to a printing ink or flexographic printing ink, in the context of aqueous flexographic printing. However, where the context allows, the disclosure and in particular features discussed should be considered as applying to printing compositions disclosed above in general.

Were the polymer particulate material or microgel particles are switchable (by which it is meant microgels of stimulus-responsive polymer) whereby the carrier-swellability is adjustable, due to some external change (switching function), between a first swollen (i.e. carrier retaining) state and a second unswollen state, it is preferred that at typical operating temperatures of flexographic printing the rheological properties of the printing composition associated with carrier-retaining/swollen polymer particles are retained. It is, therefore, preferred that the switching function (e.g. switching temperature or switching pH) is, or is adjusted to be, outside (typically above, in the case of temperature) the normal operating conditions (e.g. temperature, pH) of flexographic printing in order that the particles are present in their first swollen (carrier-retaining) state throughout the flexographic printing process. This first swollen (carrier-retaining) state may also be referred to as a ‘good solvent’ regime, whereby conditions are such that the carrier is a good solvent for the polymer particles causing them to retain solvent and swell. In this first state, the viscosity at low shear is relatively high.

The microgel may be incorporated into the flexographic printing composition of the invention in any suitable proportion to achieve the reported effect, depending upon the precise nature of the printing ink, the substrate, the microgel itself and the intended printing conditions. Preferably, the printing ink comprises a microgel particulate in an amount of from 0.1 to 50% by weight of the printing composition, more preferably from 1 to 40%, still more preferably at least 2%, still more preferably from 5 to 30% and most preferably from 10 to 25%.

The printing composition of the invention as a result of the microgel incorporation preferably has a viscosity at 0.01 Pa stress at 20° C. of at least 40 mPa·s, more preferably at least 50 mPa·s. Optionally, the printing composition comprising a microgel has a viscosity at 0.01 Pa stress at 20° C. of 100 mPa·s or greater.

The swellable particles, in situ in the printing composition according to the invention, preferably have a particle size defined by a mean diameter in the range 100 to 1500 nm and more preferably 200 to 800 nm.

The microgel particles may be prepared by any suitable monomer units that will form the corresponding microgel, typically by polymerisation, co-polymerisation, block polymerisation or otherwise.

Carrier-swellable polymer particles used according to the invention may alternatively be formed in other configurations than pure polymer particles capable of forming microgels, which have the beneficial effect. As such, the carrier-swellable polymer particles may be formed, for example in a core-shell configuration in which carrier swellable polymers or oligomers are formed on a non carrier-swellable core, which may be a solid or porous core, whereby the core-shell configuration formed has microgel-like properties. In the case of an aqueous carrier, for example, water-swellable polymer or oligomers may be tethered or grafted onto a polystyrene or other hydrophic core material.

Preferably, however, the carrier-swellable polymer/microgel particles are not core-shell particles. Preferably, also, they do not comprise or are not formed from epoxy functional resins, e.g. polyepoxy functional resins such as diepoxy functional resin. It is preferred that the carrier-swellable polymer is formed by latex synthetic methods.

The carrier-swellable polymer/microgel particles may typically be prepared, for example, by polymerisation of monomers such as N-alkylacrylamides, such as N-ethyl-acrylamide and N-isopropylacrylamide, N-alkylmethacrylamides, such as N-ethyl-methacrylamide and N-isopropylmethacrylamide, vinylcaprolactam, vinyl methyl-ethers, partially substituted vinylalcohols, ethylene oxide modified benzamide, N-acryloylpyrrolidone, N-acryloylpiperidine, N-vinylisobutyramide, hydroxy-alkylacrylates, such as hydroxyethylacrylate, hydroxyalkylmethacrylates, such as hydroxyethylmethacrylate, and copolymers thereof, by methods known in the art.

Optionally, polymer particles can also be prepared by micellisation of polymers and crosslinked while in micelles. This method applies to such polymers as, for example, certain hydroxyalkyl-celluloses, aspartic acid, carrageenan, and copolymers thereof.

The polymerization may be initiated using a charged or chargeable initiator species, such as, for example, a salt of the persulfate anion, or with a neutral initiator species if a charged or chargeable co-monomer species is incorporated in the preparation, the initial reaction between the initiator species and monomer molecules being initiated by light or heat.

Alternatively copolymers of the carrier-swellable polymer particles may be created by incorporating one or more other unsubstituted or substituted polymers such as, for example, polyacrylic acid, polylactic acid, polyalkylene oxides, such as polyethylene oxide and polypropylene oxide, polyacrylamides, polyacrylates, polyethyleneglycol methacrylate, polyvinyl alcohol, polyvinyl acetate, polyvinylpyrrolidone, polyvinyl chloride, polystyrene, polyalkyleneimines, such as polyethyleneimine, polyurethane, polyester, polyurea, polycarbonate or polyolefin.

Any polymeric acidic groups present may be partially or wholly neutralized by an appropriate base, such as, for example, sodium or potassium hydroxide, ammonia solution, alkanolamines such as methanolamine, dimethylethanolamine, triethylethanolamine or N-methylpropanolamine or alkylamines, such as triethylamine. Conversely, any amino groups present may be partially or wholly neutralized by appropriate acids, such as, for example, hydrochloric acid, nitric acid, sulfuric acid, acetic acid, propionic acid, or citric acid. The copolymers may be random copolymers, block copolymers, comb copolymers, branched, star or dendritic copolymers.

Particularly preferred polymers for use in the preparation of the carrier-swellable polymer particles of the present invention are for example, a poly-N-alkylacrylamide, especially poly-N-isopropylacrylamide, and a poly-N-alkylacrylamide-co-acrylic acid, especially poly-N-isopropylacrylamide-co-acrylic acid, poly-N-isopropylacrylamide-co-polyethyleneglycol methacrylate, polyhydroxyalkylcellulose, especially polyhydroxypropylcellulose, polyvinyl-caprolactam, polyvinylalkylethers or ethyleneoxide-propylene oxide block copolymers.

The number of monomer units in the carrier-swellable polymer particles may typically vary depending upon the size of the particles formed, as well as the nature and size of the monomers and the density of the polymer. For example, for particles from 200 nm to about 2 μm, the number of monomers in a particle may vary within the range of 1500 k to 3,000,000 k, more typically 2500 k to 750,000 k, preferably 5000 k to 50,000 k. In some instances, for larger particles, a particle may comprise at least 25,000 k monomer units. For example, these ranges may apply where the monomer units are N-isopropyleacrylamide and the particles range between 200 nm and 1 μm in the particles' second state (which may be referred to as the collapsed state) where the examples are stimulus responsive.

Generally a cross-linker may be required to maintain the shape of the polymer particle, although too high a concentration of cross-linker may inhibit the swellability of the polymer. If there is an alternative way of maintaining particle architecture, such as a core particle in a polymer shell, it may be possible in some instances, however, to exclude a cross-linker.

Suitable cross-linkers for this purpose include, for example, any materials which will link functional groups between polymer chains and the skilled artisan would choose a crosslinker suitable for the materials being used e.g. via condensation chemistry. Examples of suitable cross-linkers include N,N′-methylenebisacrylamide, N,N′-ethylenebisacrylamide, dihydroxyethylene bisacrylamide, N3N′ bis-acryloylpiperazine, ethylene glycol dimethacrylate, glycerin triacrylate, divinylbenzene, vinylsulfone or carbodiimides. The crosslinker may also be an oligomer with functional groups which can undergo condensation with appropriate functional groups on the polymer. The crosslinking material is used for partial crosslinking the polymer. The particles can also be crosslinked, for example, by heating or ionizing radiation, depending on the functional groups in the polymer.

The quantity of crosslinker used, if present, with respect to the major type of the monomer should normally be in the range of about 0.01-20 mol % of crosslinker to monomer, preferably 0.1 to 1 mol % of crosslinker to monomer and more preferably 1 to 5 mol % of crosslinker to monomer although not specifically limited thereto. This is especially the case where the polymer formed comprises N-alkylacrylamide. The quantity of crosslinker will determine the crosslinking density of the polymer particles and may adjust, for example, the swelling degree and/or phase transition temperature (if it is a switchable polymer), of the polymer.

When printing, the quantity of a functional material contained in an ink composition, for example a colorant, is defined by the printing purpose. For example, the colorant concentration could be selected such that a so-called ‘dark’ or ‘light’ ink were produced, where ‘light’ refers to an ink formulation containing a lower concentration of colorant, of similar hue, to a ‘dark’ ink. It is preferable that the quantity of functional material, such as a colorant, namely pigment or dye, in an ink composition is from about 0.1 wt % to about 50 wt %, more preferably from about 0.5 wt % to about 30 wt %, still more preferably from about 1 wt % to about 20 wt % and optionally from about 2 wt % to about 10 wt %.

Additional polymers, emulsions, or latexes may be used in the inks of the present invention. Any homopolymer or copolymer can be used in the present invention, provided it can be stabilized in an aqueous medium and is generally classified as water-soluble, water-reducible, or water-dispersible.

Although the ink composition is primarily water-based, it may be suitable in some instances to include a small amount of an organic solvent, for example up to 10% of a solvent such as, for example, ethanol, or methylethylketone to improve drying speed on the substrate. Preferably, however, the ink composition is substantially free of organic solvent.

One or more humectants may be incorporated into the printing composition. Any inclusion of humectants should be at low concentration, preferably, for example, in an amount of up to 1% by weight, even in the range 0.1 to 0.5% by weight. However, it is preferred in the present invention, especially for printing on to impermeable substrates, that humectants are not included in the composition.

Surfactants may be added to the ink to adjust the surface tension to an appropriate level or to prevent aggregation of the polymer particulates. The surfactants may be anionic: for example, salts of fatty acids, salts of dialkyl-sulfosuccinic acid, salts of alkyl and aryl sulfonates; they may be nonionic: for example, polyoxyethylene alkyl ethers, acetylene diols and their derivatives, copolymers of polyoxyethylene and polyoxypropylene, alcohol alkoxylates, sugar-based derivatives; they may be cationic: such as alkylamines, quaternary ammonium salts; or they may be amphoteric: for example, betaines. However the surfactant should normally be selected such that it is either uncharged (non-ionic), has no net charge (amphoteric) or matches the charge of the polymer used. The most preferred surfactants include acetylene diol derivatives, such as Surfynol(R) 465 (available from Air Products Corp.) or alcohol ethoxylates such as Tergitol(R) 15-S-5 (available from Dow Chemical company). The surfactants can be incorporated at levels of 0.01 to 1% of the ink composition.

A biocide may be added to the ink composition employed in the invention to suppress the growth of microorganisms such as moulds, fungi, etc. in aqueous inks. A preferred biocide for the ink composition employed in the present invention is Proxel(R) GXL (Avecia Corp.) at a final concentration of 0.0001-0.5 wt %, preferably 0.05-0.5 wt %.

Additional additives which optionally may be present include thickeners (e.g. if it is necessary to enhance the thickening properties of the microgel particles), conductivity-enhancing agents, drying agents, anti-corrosion agents, defoamers and penetrants. In some instances it may be appropriate to include an additional binder, such as a styrene acrylic or polyurethane resin, to provide further robustness to the ink, but in most instances the binding properties of the microgel polymer is likely to suffice.

The pH of the aqueous ink compositions employed in the invention may be adjusted by the addition of organic or inorganic acids or bases. Useful inks may have a preferred pH of from 2 to 11, preferably 7 to 9, depending upon the type of pigment or dye being used. Typical inorganic acids include hydrochloric, phosphoric and sulfuric acids. Typical organic acids include methanesulfonic, acetic and lactic acids. Typical inorganic bases include alkali metal hydroxides and carbonates. Typical organic bases include ammonia, triethanolamine and tetramethylethlenediamine.

The inks used in accordance with the present invention comprising a functional material are preferably colorants can be dye-based or pigment-based.

### Pigment-Based Inks

Any suitable pigment according to the requirements of the application may be utilized in the inks formed according to the present invention. The pigment inks may be made by any suitable method know to those skilled in the art.

The process of preparing inks from pigments commonly involves two steps: (a) a dispersing or milling step to break up the pigment to the primary particle, and (b) a dilution step in which the dispersed pigment concentrate from step (a) is diluted with a carrier and other addenda to a working strength ink. In the milling step, the pigment is usually suspended in a carrier (typically the same carrier as that in the finished ink) along with rigid, inert milling media. Mechanical energy is supplied to this pigment concentrate, and the collisions between the milling media and the pigment cause the pigment to deaggregate into its primary particles. A dispersant or stabilizer, or both, may be added to the dispersed pigment concentrate to facilitate deaggregation, maintain particle stability and, retard particle reagglomeration and settling.

Any suitable milling media may be used, including, for example, polymeric resin beads. Milling can take place in any suitable grinding mill. Suitable mills include an air jet mill, a roller mill, a ball mill, an attritor mill and a bead mill. A high-speed, high-energy mill is preferred by which the milling media obtain velocities greater than 5 m/s.

The dispersant is an optional ingredient used to prepare the dispersed pigment concentrate. Dispersants which could be used in the present invention include sodium dodecyl sulfate, acrylic and styrene-acrylic copolymers, such as those disclosed in U.S. Pat. Nos. 5,085,698 and 5,172,133 and sulfonated polyesters and styrenics, such as those disclosed in U.S. Pat. No. 4,597,794. Other patents referred to above in connection with pigment availability also disclose a wide variety of dispersant from which to select. Non-ionic dispersants could also be used to disperse pigment particles. Dispersants may not be necessary if the pigment particles themselves are stable against flocculation and settling. Self-dispersing pigments are an example of pigments that do not require a dispersant; these types of pigments are well known in the art.

The pigment particles useful in the invention may have any suitable particle size. The pigment particles, for example, may have a mean particle size of up to 0.5 μm. Preferably, the pigment particles have a mean particle size of 0.3 μm or less, more preferably 0.15 μm or less. A wide variety of organic and inorganic pigments, alone or in combination, may be selected for use in the inks of the present invention. Pigments that may be used in the invention include those disclosed in, for example, U.S. Pat. Nos. 5,026,427; 5,086,698; 5,141,556; 5,160,370; and 5,169,436. The exact choice of pigments will depend upon the specific application and performance requirements, such as color reproduction and image stability.

Pigments suitable for use in the present invention include, for example, azo pigments, monoazo pigments, disazo pigments, azo pigment lakes, [beta]-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide and especially carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 61, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; and CL Pigment Blue 1, 2, 9, 10, 14, 15:1, 15:2, 15:3, 15:4, 15:6, 15, 16, 18, 19, 24:1, 25, 56, 60, 61, 62, 63, 64, 66. In a preferred embodiment of the invention, the pigment is CA, Pigment Black 7, C.I. Pigment Blue 15:3, C.I. Pigment Red 122, C.I. Pigment Yellow 155, C.I. Pigment Yellow 74, or a bis(phmalocyanylalumino)tetraphenyldisiloxane as described in U.S. Pat. No. 4,311,775.

Commercially used pigment preparations could also be used, such as the IDIS™ series of pigment dispersions by Evonik Degussa or the Hostafine series of pigment preparations of Clariant, such as Hostafine™ Black TS, Blue B2G, Magenta E VP, Yellow GR (which uses Pigment Yellow 13) and Yellow HR (which uses Pigment Yellow 83), or the Hostajet series of pigment dispersions of Clariant, such as the PT and the ST series.

Particularly preferred pigments for use in this invention are, for example, PNB15-3 (cyan), PR122 (magenta), PY74 (yellow), IDIS™ 40 and especially Carbon K (black).

The pigment used in the ink composition of the invention may be used in any effective amount, generally from 0.1 to 50 wt. %, preferably from 0.5 to 30 wt. %, more preferably 1 to 20 wt % and optionally 2 to 10 wt %.

### Dye Based Inks.

Alternatively the colorants which could be used in this invention could be dyes including water-soluble dyes such as: CI Direct Black 2, 4, 9, 11, 17, 19, 22, 32, 80, 151, 154, 168, 171, 194, 199; C.I. Direct Blue 1, 2, 6, 8, 22, 34, 70, 71, 76, 78, 86, 112, 142, 165, 199, 200, 201, 202, 203, 207, 218, 236, 287; CL Direct Red 1, 2, 4, 8, 9, 11, 13, 15, 20, 28, 31, 33, 37, 39, 51, 59, 62, 63, 73, 75, 80, 81, 83, 87, 90, 94, 95, 99, 101, 110, 189; CI Direct Yellow 1, 2, 4, 8, 11, 12, 26, 27, 28, 33, 34, 41, 44, 48, 51, 58, 86, 87, 88, 132, 135, 142, 144; C.I. Acid Black 1, 2, 7, 16, 24, 26, 28, 31, 48, 52, 63, 107, 112, 118, 119, 121, 156, 172, 194, 208; C.I. Acid Blue 1, 7, 9, 15, 22, 23, 27, 29, 40, 43, 55, 59, 62, 78, 80, 81, 83, 90, 102, 104, 111, 185, 249, 254; C.I. Acid Red: 1, 4, 8, 13, 14, 15, 18, 21, 26, 35, 37, 52, 110, 144, 180, 249, 257, C.I. Acid Yellow 1, 3, 4, 7, 11, 12, 13, 14, 18, 19, 23, 25, 34, 38, 41, 42, 44, 53, 55, 61, 71, 76, 78, 79, 122; C.I. Reactive Red 23, 180; Reactive Black 31; Reactive Yellow 37; water soluble Duasyn™ dyes (from Clariant), water-soluble Irgasperse™ dyes (from Ciba). The dyes can be photochrome, thermochromic or fluorescent.

The support for the substrate used in the invention can be any of those usually used for flexographic printing, but it is a particular advantage of the present invention that that it can be used for printing onto ‘low energy’ impermeable substrates, such as, for example, polyethylene and polypropylene. Normally printing onto low energy substrates often involves the use of corona discharge treatment or prior treatment with primers to enable good adhesion. It is a feature of this invention that such pretreatments are not usually necessary. Preferably, the method of printing may be carried out in the absence of corona discharge treatment. Although the composition of the present invention can also be used with permeable substrates, as detailed hereunder, printing onto non-porous substrates is especially preferred, and can also include substrates such as glass, diamond, borosilicates, silicon, germanium and metals such as aluminium, steel or copper. Accordingly high surface energy substrates may be beneficially printed using the carrier-swellable polymer particle-containing inks of the invention. Optionally, for high energy surface impermeable substrates, copolymer microgels may be used for enhanced adhesion. For example, amino co-monomers (especially as co-monomers to NIPAM) may be advantageous for printing, for example, on glass surfaces whilst carboxylic acid co-monomers (especially as co-monomers to NIPAM) may be advantageous for printing, for example, on aluminium surfaces.

Conventional substrates include, for example, resin-coated paper, paper, polyesters, or microporous materials such as polyethylene polymer-containing material sold by PPG Industries, Inc., Pittsburgh, Pa. under the trade name of Teslin (R), Tyvek (R) synthetic paper (DuPont Corp.) and OPPalyte(R) films (Mobil Chemical Co.) and other composite films listed in U.S. Pat. No. 5,244,861. Opaque supports include plain paper, coated paper, synthetic paper, photographic paper support, melt-extrusion-coated paper and Laminated paper, such as biaxially oriented support laminates. Biaxially oriented support laminates ate described in U.S. Pat. Nos. 5,853,965; 5,866,282; 5,874,205; 5,888,643; 5,888,681; 5,888,683; and 5,888,714. These biaxially oriented supports include a paper base and a biaxially oriented polyolefin sheet, typically polypropylene, laminated to one or both sides of the paper base. Polymeric supports also include cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthenate), poly(1,4-cyclo-hexanedimethylene terephthalate), poly(butylene terephthalate), and copolymers thereof; polyimides; polyamides; polycarbonates; polystyrene; polyolefins, such as polyethylene, polypropylene or polybutylene; polysulfones; polyacrylates; polyetherimides; polyvinyl chloride; polyvinylacetate; polyvinylamine; polyurethane; polyacrylonitrile; polyacetal; polytetrafluoroethene; polyfluorovinylidene; polysiloxane; polycarboranes; polyisoprene; rubber and mixtures thereof.

These materials can be coated or laminated onto other substrates or extruded as sheets or fibres; the latter can be woven or compressed into porous but hydrophobic substrates, such as Tyvek (R), and mixtures thereof. The papers listed above include a broad range of papers, from high end papers, such as photographic paper, to low end papers, such as newsprint.

When the support used in the invention is a paper support, it may have a thickness of from 50 to 1000 μm, preferably from 75 to 300 μm. Antioxidants, antistatic agents, plasticizers and other known additives may be incorporated into the support, if desired.

Whilst the composition of the invention avails the user of the option to neglect a corona discharge step, the option of conducting a corona discharge step in order to improve the adhesion of an ink-receiving substrate surface remains. Known coating and drying methods are described in further detail in Research Disclosure no. 308119, published December 1989, pages 1007 to 1008. Research Disclosure is a publication of Kenneth Mason Publications Ltd., Dudley House, 12 North Street, Emsworth, Hampshire PO 107DQ5 United Kingdom. After printing, the ink is generally dried by simple evaporation, which may be accelerated by known techniques such as convection heating. Any further post-printing coating composition can be coated either from water or organic solvents, however water is preferred. The total solids content should be selected to yield a useful coating thickness in the most economical way.

The patents and publications referred to herein are incorporated by reference in their entirety.

It has also been found particularly advantageous in a preferred embodiment of the invention to incorporate a surfactant or dispersant into the flexographic printing ink of the invention to improve the density of and reduce mottling in areas of solid colour. The surfactant may be incorporated in an amount from 0.01%, optionally from 0.1% and even from 0.5% by weight of the ink composition to about 10% by weight. Preferably, for the most beneficial effect, the surfactant/dispersant is incorporated in an amount of at least 1% by weight, more preferably in the range 1 to 5% by weight of the ink composition, optionally up to 2%, and still more preferably 1.2 to 1.5% by weight. For aqueous systems with water-swellable microgel, it is preferred to use an anionic surfactant for this purpose, of which sodium dodecyl sulfate is the preferred. Preferably, the surfactant/dispersant is present in an amount such that the microgel to surfactant/dispersant ratio is from 5:1 to 1:1 preferably 4:1 to 2.5:1. The use of a surfactant in this manner provides improved density of solid printed areas and less mottling.

The invention will now be described with reference to the following examples, which are however, in no way to be considered limiting thereof.

### EXAMPLES

### Example 1

A microgel based ink formulated using 4% microgel was prepared using 7.9 g of N-isopropylacrylamide (NIPAM), 0.151 g of methylenebisacrylamide (BIS), 0.256 g potassium persulfate (KPS) and 460 g of water. In a 1 litre double-wall glass reactor with mechanical stirring, refrigerant and N₂ inlet, the NIPAM was added to half the BIS at a reactor temperature of 40° C. With the solution stirred at 200 rpm and purged with N₂ for 1 hour, once purged, the temperature was increased to 70° C. The KPS was dissolved in 10 ml deionised (DI) water at room temperature. The other half of the BIS (0.0755 g) was also dissolved in 10 ml DI water. The KPS initiator solution was poured into the reactor in one shot. The BIS solution was added into the reactor dropwise over the next 30 minutes. The dispersion was mixed for 6 hours then left to cool overnight at room temperature. The dispersion was filtered on filter paper to remove any residues from the stirrer bar using a Buchner filter with pump and then purified by dialysis against DI water until conductivity is below 5 microS/cm.

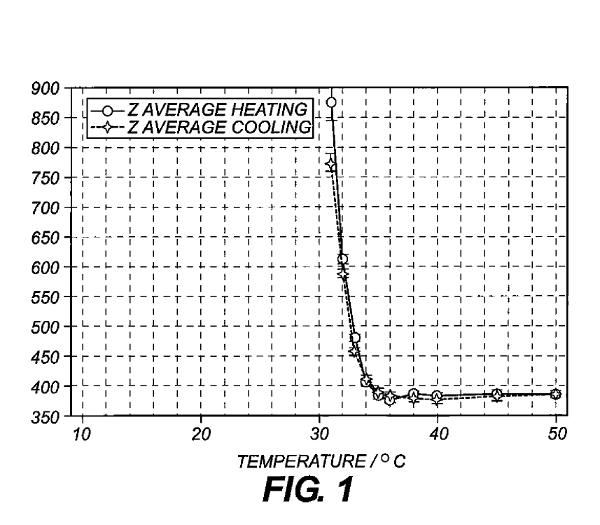

The particle size of the suspension of these thermally-sensitive particles was measured by photon correlation spectroscopy, PCS, and determined with a Malvern ZetasizerNano™ ZS. A dilute sample of thermally-sensitive particles was obtained from the purified sample and was diluted with milli-Q water, a typical sample concentration being 0.05 wt %. Samples were equilibrated at each temperature for 10 minutes and then the size was measured 5 times, such that the total time at each temperature was approximately 25 minutes. The results quoted are the mean of the measurements. The hydrodynamic diameter was measured as 383 nm at 50° C. and 610 nm at 32° C., but cannot be measured below this temperature as the fully swollen size is above 1 micron and outside the measurement range of the apparatus. FIG. 1 shows a graph of particle size (nm) against temperature (° C.) according to the above microgel particle measurements.

A printing ink was formulated using 4% microgel, 6% carbon black pigment (IDIS 40, Evonik), 0.19% Surfynol™ 104 (Air Products) and 0.12% sodium dodecyl sulfate (SDS, Fluka). The ink was mixed by rolling on ball mill for several hours. The ink was flexographically printed onto PET substrate using an EASIproof™ flexographic printer (RK Print Ltd., Royston) to print large areas of solid ink.

### Example 2

A printing ink was formulated using 4% microgel from Example 1, 6% carbon black pigment (IDIS 40. Evonik), 0.19% Surfynol™ 104 (Air Products) and 1.2% sodium dodecyl sulfate (SDS, Fluka). The ink was mixed by rolling on ball mill for several hours. The ink was flexographically printed onto PET substrate using an EASIproof™ flexographic printer (RK Print Ltd. Royston) to print large areas of solid ink.

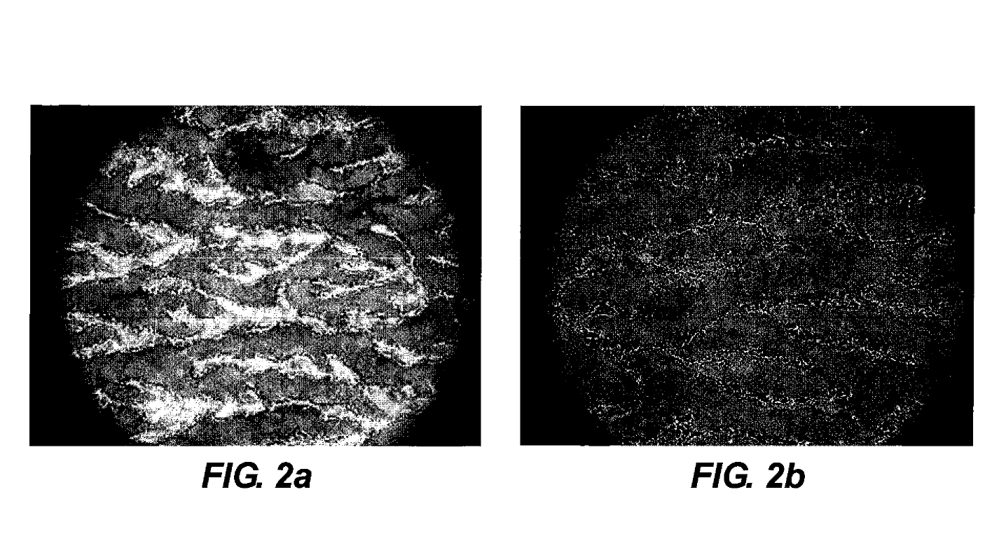

A comparison of the uniformity of the printed regions with the low SDS concentration of Example 1 and the high concentration of SDS of Example 2 is shown in the optical micrographs of FIG. 2. The darker areas of the image are inked areas. FIG. 2a shows a micrograph of approximately 2 mm square area of the printed ink sample from Example 1 with 0.12% SDS, whilst FIG. 2b shows the same sized area of the printed ink sample from Example 2 with 1.2% wt SDS. It is clear from the images that the sample with higher SDS concentration gives more uniform ink coverage.

### Example 3

### Improved Resolution and Reduced Sensitivity to Printing Parameters

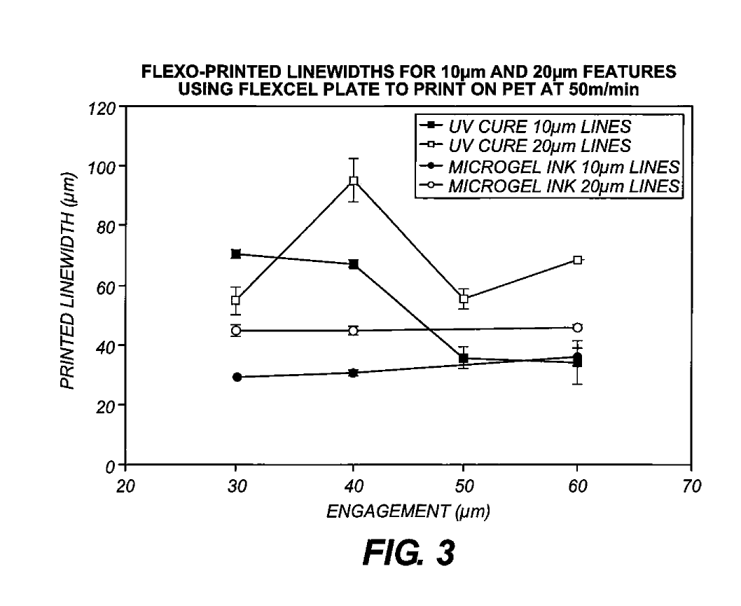

An ink was formulated as in Example 2. The ink was flexographically printed onto a sample of PET using an RK Flexiproof™ 100 (RK Print Ltd., Royston). A Kodak Flexcel™ plate was mounted on the Flexiproof™ using two layers of rigid double sided plate mounting tape to ensure the correct plate thickness. The anilox was a ceramic, laser engraved 800 lpi. All experiments were performed at ambient temperature which was approximately 18-20° C. Substrate speed was 50 m/min. The point of kiss contact and optimum pressures were determined using Flexocure Gemini™ (Flint inks) UV-curable ink since it does not dry. The effects of different levels of engagement pressure on the printed line width were investigated (where kiss contact is at 0 μm engagement). FIG. 3 shows a comparison of the printed line width for both 10 μm and 20 μm wide lines on the plate, using both the UV-curable ink and the microgel-containing ink. It is clear from the Figure that the line widths are lower and more consistent at all levels of engagement, using the multifunctional ink compared to the UV-curable ink.

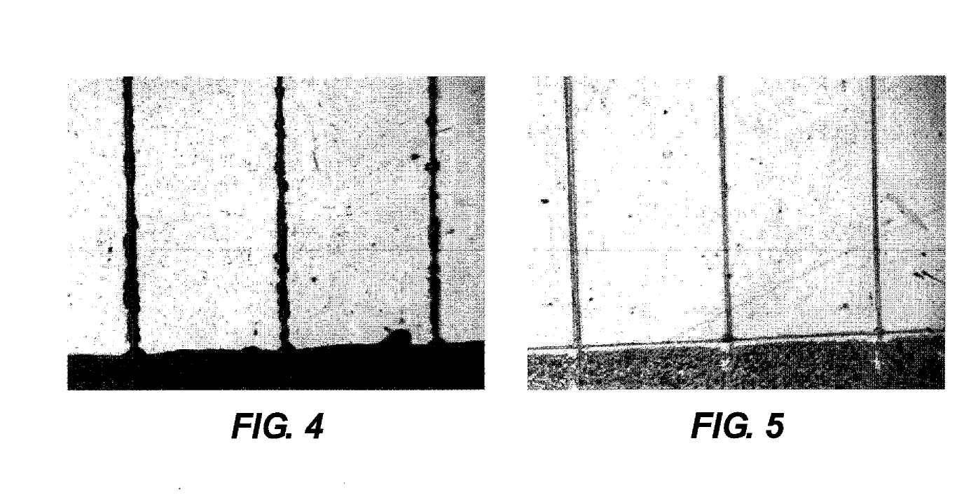

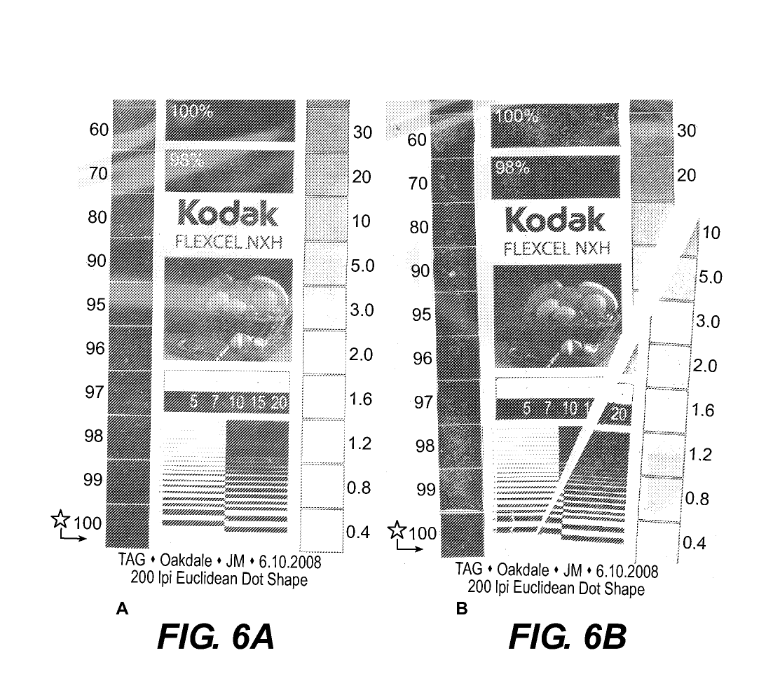

FIG. 4 shows images of the 10 μm and 20 μm features printed with the UV-curable ink at 60 μm engagement and FIG. 5 shows the comparable lines printed with the aqueous microgel-containing ink. It is clear that the lines printed with the microgel-containing ink are sharper, more consistent and have much straighter edges compared to those printed with the UV-curable ink.

### Example 4

### Printing on Untreated Hydrophobic Surfaces

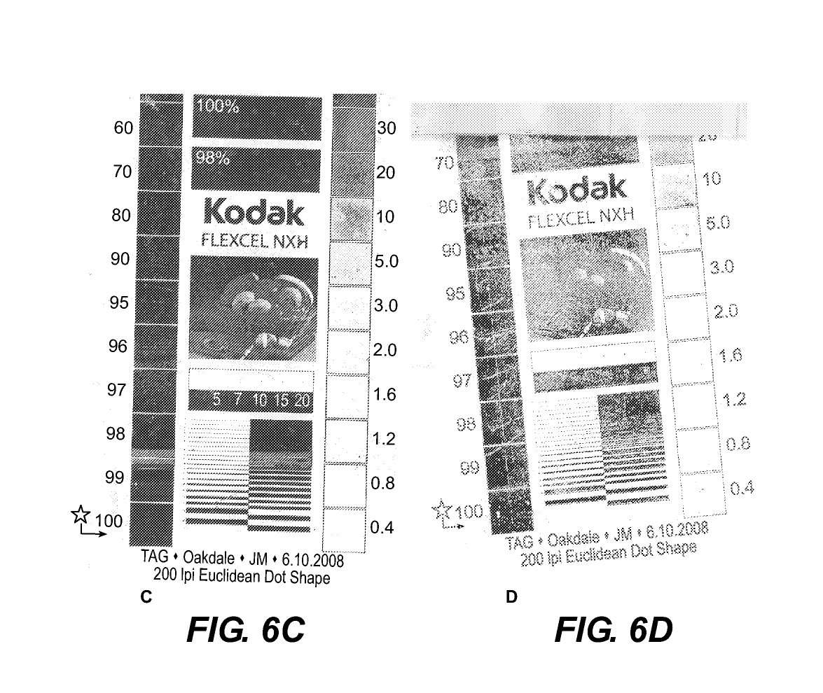

An ink was formulated as in Example 2. The ink was flexographically printed onto both sides a sample of biaxially orientated polypropylene (BOPP) (Rayoface™ W28 supplied by Innovia Films) using an RK Flexiproof™ 100 (RK Print Ltd., Royston). The substrate had been treated with a corona discharge on one side to raise the surface energy and improve the adhesion, but was untreated on the other side. A Kodak Flexcel™ plate was mounted on the Flexiproof using two layers of rigid double sided plate mounting tape to ensure the correct plate thickness. The anilox was a ceramic, laser engraved 800 lpi. All experiments were performed at ambient temperature which was approximately 18-20° C. Substrate speed was 50 m/min. As a comparison, both the treated and the untreated sides of the BOPP substrate were printed with UV-curable ink (Flexocure Gemini, Flint inks). The four printed samples are shown in FIG. 6.

In FIG. 6, samples of BOPP are shown printed with microgel-containing ink and UV-curable ink on both the CDT treated and untreated sides. FIGS. 6A to 6D are as follows. A: Microgel ink on CDT treated BOPP, B: Microgel ink on BOPP with no CDT treatment, C: UV-curable ink on CDT treated BOPP, D: UV-curable ink on BOPP with no CDT treatment.

It is clear from the comparison between FIGS. 6A and 6B (which show respectively the microgel-containing ink printed on a substrate which has been subject to corona discharge treatment and on a substrate which has not been subject to corona discharge treatment) that adhesion of the printed microgel-containing ink onto the low-energy substrate is very good whether or not the substrate has been treated with a corona discharge, the untreated surface only marginally less consistent. In comparing the UV-curable ink printed respectively on the corona discharge treated surface (FIG. 6C) and the untreated surface (FIG. 6D), it is clear that the UV-curable ink adheres very poorly to an untreated surface as compared with a treated surface. Furthermore, the untreated surface has much better printed characteristics when printed with a microgel-containing ink as compared with the UV-curable ink (compare FIGS. 6B and 6D).

It will be understood that the descriptions above are examples to illustrate the invention only and that many more applications fall within the scope of the claims.

1. A method of enhancing printing performance in a flexographic printing process comprising: incorporating carrier-swellable polymer particles into a flexographic printing ink formulation, which ink formulation comprises a carrier capable of swelling the carrier-swellable polymer particles; inking an anilox roler with the printing ink formulation; and transferring the printing ink formulation from the anilox roller to a flexographic printing plate.

2. A method as claimed in claim 1 wherein the carrier-swellable polymer particles are microgel particles.

3. A method as claimed in claim 1 wherein the flexographic printing ink is an aqueous flexographic printing ink and wherein the carrier-swellable polymer particles are water-swellable microgel particles.

4. A method as claimed in claim 1, wherein the particles are incorporated in an amount of from 2 to 20 wt % based on the total weight of the resulting composition.

5. A method as claimed in claim 1 wherein the carrier-swellable polymer particles, in their first (swollen) state, have a mean diameter greater than 1 μm.

6. A method as claimed in claim 1, wherein the polymer particles are derived from monomers comprising one or more of the class consisting of N-alkylacrylamides, N-alkylmethacrylamides, vinylcaprolactam, vinylmethylethers, partially substituted vinylalcohols, ethylene oxide modified benzamide, N-acryloylpyrrolidone, N-acryoylpiperidine, N-vinylisobutyramide, hydroxyalkylacrylates, and hydroxyalkylmethacrylates.

7. A method as claimed in claim 1, wherein the polymer particles are selected from the class consisting of hydroxyalkyl-celluloses, aspartic acid, carrageenan and copolymers thereof.

8. A method as claimed in claim 1 wherein the polymer particles are copolymers derived by incorporation of one or more unsubstituted or substituted polymers selected from polyacrylic acid, polylactic acid, polyalkylene oxides, polyacrylamides, polyacrylates, polyethyleneglycol methacrylate, polyvinyl alcohol, polyvinyl acetate, polyvinylpyrrolidone, polyvinyl chloride, polystyrene, polyalkyleneimines, polyurethane, polyester, polyurea, polycarbonate and polyolefines.

9. A method as claimed in claim 1, wherein the polymer particle is poly-N-isopropylacrylamide.

10. A method as claimed in claim 1, wherein the polymer particle is poly-N-isopropylacrylamide-co-acrylic acid or poly-N-iso-propylacrylamide-co-polyethyleneglycol methacrylate.

11. A method as claimed in claim 1 any one of the preceding claims wherein a crosslinker is present to link functional groups between polymer chains of the polymer particles.

12. A method as claimed in claim 11, wherein the crosslinker is selected from the class consisting of N,N′-methylenebisacrylamide, N,N′-ethylene-bisacrylamide, dihydroxyethylene bisacrylamide, bis-acryloylpiperazine, ethylene glycol dimethacrylate, glycerin triacrylate, divinylbenzene, vinylsulfone and carbodiimides.

13. A method as claimed in claim 12, wherein the amount of crosslinker is from 0.01 to 20 mol % of crosslinker to monomer.

14. A method as claimed in claim 1 whereby the viscosity of the printing ink during the printing process is 50 mPa·s or more at a stress of 0.01 Pa.

15. A method as claimed in claim 1, further comprising improving colour density and/or reducing mottling in solid print areas from the flexographic printing process by incorporating into said ink composition a surfactant in an amount of greater than 0.5% by weight of the ink composition.

16. A method as claimed in claim 15, wherein the surfactant is incorporated whereby the wt/wt ratio of polymer particulate material to surfactant is in the range from 1:1 to 5:1.

17. A flexographic printing composition comprising a functional component and a carrier characterised in that it further comprises a carrier-swellable polymer particulate material.

18. A flexographic printing composition as claimed in claim 17, which has a viscosity of 50 mPa·s or greater at a stress of 0.01 Pa at 20° C.

19. A method as claimed in claim 1, wherein the flexographic printing ink is manufactured by preparing a water-swellable microgel by polymerising one or more monomer in the presence of a crosslinker and a polymerisation initiator under conditions to cause internal crosslinking of the resulting polymers and minimal continuous phase crosslinking; and formulating the microgel in an aqueous composition comprising the microgel, water and a functional material together with one or more surfactants.

20. A method as claimed in claim 1 comprising the steps of: providing a flexographic printing apparatus comprising an anilox roller and a flexographic printing plate carrying a relief image according to a desired image; providing the flexographic printing ink with incorporated carrier-swellable polymer particles, inking the anilox roller with the printing ink and causing metered ink to be transferred from the anilox roller to the flexographic printing plate and subsequently onto a substrate on which the image is to be formed.
